(19) United States
(12) Patent Application Publication
(10) Pub. No.: US 2019/0218818 A1
(43) Pub. Date: Jul. 18, 2019

(54) REPLACEMENT DOOR HANDLE SYSTEM AND METHODS

(71) Applicant: Randall Leamon Hewitt, Calgary (CA)

(72) Inventor: Randall Leamon Hewitt, Calgary (CA)

(21) Appl. No.: 15/871,938

(22) Filed: Jan. 15, 2018

(51) Int. Cl. E05B 1/00

(52) U.S. Cl. CPC E05B 1/0015; F25D 23/028

(57) ABSTRACT

Replacement handle systems and methods involving: a replacement handle having two distal ends, the replacement handle including at least one of: a polymer material, a metallic material, a ceramic material, and a composite material; and an adhesive component for coupling the replacement handle with an appliance door surface, the adhesive component including at least one of a foam pad and an adhesive material, the adhesive component providing a high-strength bond between the replacement handle and the appliance door surface, and the adhesive component having an adhesive strength in a minimum range of approximately 1.1 MPa to approximately 1.8 MPa, whereby decoupling of the replacement handle from the appliance door surface is minimized.

### TECHNICAL FIELD

Generally, the present disclosure technically relates to door handles. More particularly, the present disclosure technically relates to after-market door handles. Even more particularly, the present disclosure technically relates to easy-installation pre-market, market, as well as after-market door handles for refrigerators and freezers.

### BACKGROUND

In the related art, refrigerators, freezers, and their combinations, tend to experience excessive use and wear by tenants over time in an apartment building. While such units may have a low initial cost upon purchase by the landlord, finding replacement parts often becomes at least one of difficult, costly, untimely, and unavailable. Related art replacement door handles also involve fittings, e.g., a plurality of brackets, and fasteners, e.g., a plurality of screws or nuts-and-bolts, which may be difficult for the average consumer to use or for which the average consumer may not have the appropriate tools.

### SUMMARY

In addressing at least many of the challenges experienced in the related art, the subject matter of the present disclosure generally involves replacement door handle systems and methods for appliances, such as refrigerators and freezers, e.g., apartment-size refrigerators and freezers or combinations thereof, e.g., in a volume range of approximately 9 ft³ to approximately 20 ft³. The replacement door handle systems and methods are inexpensive, readily manufacturable, easy to install, and universally configured. The systems and methods of the present disclosure provide easy-installation of pre-market, market, and after-market door handles for appliances, such as refrigerators and freezers, and are expected to significantly streamline the manufacturing process and reduce manufacturing costs.

In accordance with an embodiment of the present disclosure, a replacement handle system comprises: a replacement handle having two distal ends, the replacement handle comprising at least one of: a polymer material, a metallic material, a ceramic material, and a composite material; and an adhesive component for coupling the replacement handle with an appliance door surface, the adhesive component comprising at least one of a foam pad and an adhesive material, the adhesive component providing a high-strength bond between the replacement handle and the appliance door surface, and the adhesive component comprising an adhesive strength in a minimum range of approximately 1.1 MPa to approximately 1.8 MPa, whereby decoupling of the replacement handle from the appliance door surface is minimized.

In accordance with an embodiment of the present disclosure, a method of fabricating a replacement handle system comprises: providing a replacement handle having two distal ends, providing the replacement handle comprising providing at least one of: a polymer material, a metallic material, a ceramic material, and a composite material; and providing an adhesive component for coupling the replacement handle with an appliance door surface, providing the adhesive component comprising providing at least one of a foam pad and an adhesive material, providing the adhesive component comprising providing a high-strength bond between the replacement handle and the appliance door surface, and providing the adhesive component comprising providing an adhesive strength in a range of approximately 1.1 MPa to approximately 1.8 MPa, whereby decoupling of the replacement handle from the appliance door surface is minimized.

In accordance with an embodiment of the present disclosure, a method of replacing a handle, by way of a replacement handle system, comprises: providing the replacement handle system, providing the system comprising: providing a replacement handle having two distal ends, providing the replacement handle comprising providing at least one of: a polymer material, a metallic material, a ceramic material, and a composite material; and providing an adhesive component for coupling the replacement handle with an appliance door surface, providing the adhesive component comprising providing at least one of a foam pad and an adhesive material, providing the adhesive component comprising providing a high-strength bond between the replacement handle and the appliance door surface, and providing the adhesive component comprising providing an adhesive strength in a minimum range of approximately 1.1 MPa to approximately 1.8 MPa, whereby decoupling of the replacement handle from the appliance door surface is minimized; and coupling the replacement handle with the appliance surface by way of the adhesive component.

Some of the features in the present disclosure are broadly outlined in order that the section, entitled Detailed Description, is better understood and that the present contribution to the art by the present disclosure is better appreciated. Additional features of the present disclosure are described hereinafter. In this respect, understood is that the present disclosure is not limited in its implementation to the details of the components or steps as set forth herein or as illustrated in the several figures of the Drawing, but are capable of being carried out in various ways which are also encompassed by the present disclosure. Also, understood is that the phraseology and terminology employed herein are for illustrative purposes in the description and are not regarded as limiting.

### BRIEF DESCRIPTION OF THE DRAWING

The above, and other, aspects, and features, of the several embodiments in the present disclosure will be more apparent from the following Detailed Description as presented in conjunction with the following several figures of the Drawing.

FIG. 1 is a diagram illustrating a side view of a replacement handle system, in accordance with an embodiment of the present disclosure.

FIG. 1a is a diagram illustrating a partial side view of a replacement handle system, in accordance with an embodiment of the present disclosure as illustrated in FIG. 1.

FIG. 2 is a diagram illustrating a rear view of the replacement handle system, as shown in FIG. 1, in accordance with an embodiment of the present disclosure.

FIG. 3 is a flow diagram illustrating a method of fabricating a replacement handle system, as shown in FIG. 1, in accordance with an embodiment of the present disclosure.

FIG. 4 is a flow diagram illustrating a method of replacing a handle, by way of a replacement handle system, as shown in FIG. 1, in accordance with an embodiment of the present disclosure.

Corresponding reference numerals or characters indicate corresponding components throughout the several figures of the Drawing. Elements in the several figures are illustrated for simplicity and clarity and have not necessarily been drawn to scale. For example, the dimensions of some elements in the figures are emphasized relative to other elements for facilitating understanding of the various presently disclosed embodiments. Also, well-understood elements that are useful or necessary in commercially feasible embodiment are often not depicted to facilitate a less obstructed view of these various embodiments of the present disclosure.

### DETAILED DESCRIPTION

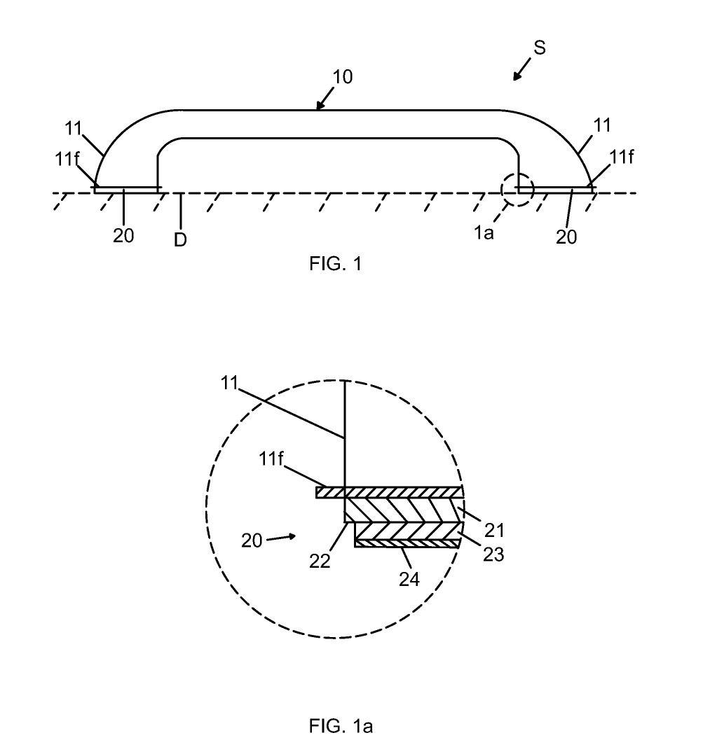

Referring to FIGS. 1 and 1a, these diagram illustrates, in a side view, a replacement handle system S, in accordance with an embodiment of the present disclosure. The replacement handle system S comprises: a replacement handle 10 having two distal ends 11, the replacement handle 10 comprising at least one of: a polymer material, a metallic material, a ceramic material, and a composite material; and an adhesive component 20 for coupling the replacement handle 10 with an appliance door surface D, the adhesive component 20 comprising a foam pad 21 and an adhesive material 23, the adhesive component 20 providing a high-strength bond between the replacement handle 10 and the appliance door surface D, and the adhesive component 20 comprising an adhesive strength in a minimum range of approximately 1.1 MPa to approximately 1.8 MPa, whereby decoupling of the replacement handle 10 from the appliance door surface D is minimized.

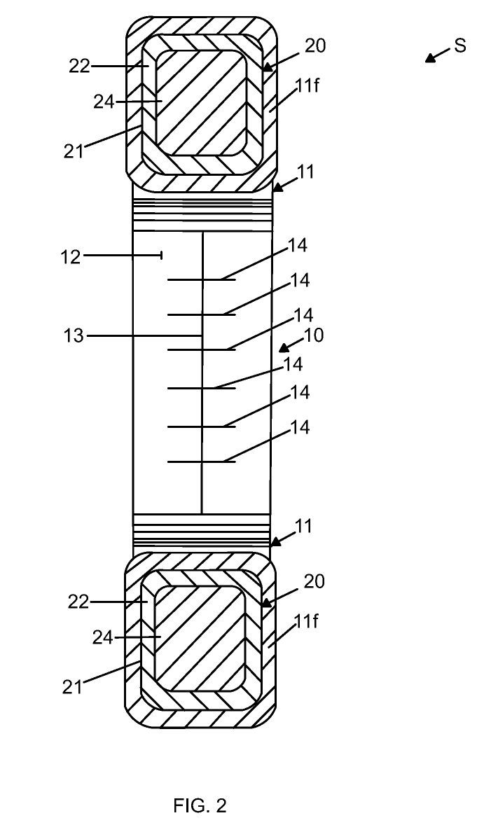

Referring to FIG. 2, this diagram illustrates, in a rear view, the replacement handle system S, as shown in FIG. 1, in accordance with an embodiment of the present disclosure. In the system S, the replacement handle 10 comprises a generally elongated curvilinear configuration. The replacement handle 10 comprises a length in a range of approximately 12 inches to approximately 20 inches, and a preferred length in a range of approximately 12 inches to approximately 16 inches. The replacement handle 10 comprises: a generally hollow configuration 12; and at least one of: at least one rib 14 and at least one spar 13. Alternatively, the replacement handle 10 comprises a solid configuration. The replacement handle 10 is light-weight and comprises a weight range of approximately 80 grams to approximately 100 grams.

Still referring to FIG. 2, each distal end 11 of the two distal ends 11 comprises a generally flat surface; and each distal end 11 of the two distal ends 11 comprises a generally rectangular shape. The adhesive component 20 comprises: two pad portions 21 having two generally planar pad surfaces 22; an adhesive material 23 disposed on each pad surface 22; and two release plies 24 disposed on the adhesive material 23, wherein one generally planar pad surface 22 of each pad portion 21 is coupled with each distal end 11 of the replacement handle 10 by way of the adhesive material 23.

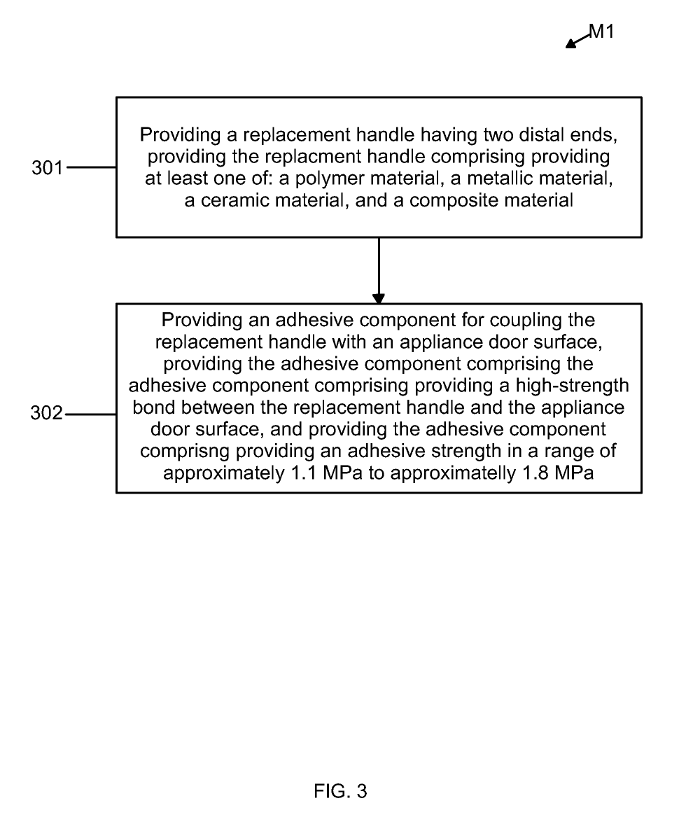

Still referring to FIG. 2, in the system S, each distal end 11 of the replacement handle 10 further comprises a flange 11f for providing additional structural stability. The flange 11f comprises a width of approximately 1/16 inch and is integrally formed. Alternatively, the adhesive component 20 is disposable on both the generally flat surface of the distal end 11 as well as the flange 11f. The release ply 24 (FIG. 3) of the adhesive component 20 may peeled away; and the adhesive material 23 may then be coupled with the both the generally flat surface of the distal end 11 as well as the flange 11f, wherein the t adhesive component 20 comprises a “double-stick” configuration. Subsequently, the other release ply 24 may peeled away; and the other adhesive material 23 may then be coupled with the appliance door surface D.

Still referring to FIG. 2, in the system S, the replacement handle 10 is formed by a process comprising at least one of: casting, molding, vacuum-molding, injection-molding, and extruding. The replacement door handle 10 comprises at least one of a sustainable material, a recyclable material, and a recycled material, wherein the sustainable material comprises a sustainable wood product, e.g., a bamboo product, by example only, and herein the recyclable or recycled material comprises polyethylene, by example only. Additionally, in the system S, the adhesive component 20 comprises a material, such as a Bond Tech® adhesive, a 3M Adhesive®, and a Facto® adhesive, by examples only.

Referring to FIG. 3, this flow diagram illustrates a method M1 of fabricating a replacement handle system S, as shown in FIG. 1, in accordance with an embodiment of the present disclosure. The method M1 comprises: providing a replacement handle 10 having two distal ends 11, providing the replacement handle 10 comprising providing at least one of: a polymer material, a metallic material, a ceramic material, and a composite material, as indicated by block 301; and providing an adhesive component 20 for coupling the replacement handle 10 with an appliance door surface D, providing the adhesive component 20 comprising providing at least one of a foam pad 21 and an adhesive material 23, providing the adhesive component 20 comprising providing a high-strength bond between the replacement handle 10 and the appliance door surface D, and providing the adhesive component 20 comprising providing an adhesive strength in a range of approximately 1.1 MPa to approximately 1.8 MPa, as indicated by block 302, whereby decoupling of the replacement handle 10 from the appliance door surface D is minimized.

Still referring to FIG. 3, in the method M1, providing the replacement handle 10, as indicated by block 301, comprises providing the replacement handle 10 with a generally elongated curvilinear configuration. Providing the replacement handle 10, as indicated by block 301, comprises providing the replacement handle 10 with a length in a range of approximately 12 in to approximately 16 in. Providing the replacement handle 10, as indicated by block 301, comprises: providing a generally hollow configuration 12; and providing at least one of: at least one rib 14 and at least one spar 13. Providing the replacement handle 10, as indicated by block 301, comprises providing the replacement handle 10 as light-weight and with a weight in a range of approximately 80 grams to approximately 100 grams. Alternatively, providing the replacement handle 10, as indicated by block 301, comprises providing the replacement handle 10 with a solid configuration.

Still referring to FIG. 3, in the method M1, providing the replacement handle 10, as indicated by block 301, comprises providing each distal end 11 of the two distal ends 11 with a generally flat surface. Providing the replacement handle, as indicated by block 301, comprises providing each distal end 11 of the two distal ends 11 with a generally rectangular shape. Providing the adhesive component 20, as indicted by block 302, comprises: providing two pad portions 21 having two generally planar pad surfaces 22; providing an adhesive material 23 disposed on each pad surface 22; and providing two release plies 24 disposed on the adhesive material 23, wherein providing the two pad portions 21 comprises coupling one generally planar pad surface 22 of each pad portion 21 with each distal end 11 of the replacement handle 10 by way of the adhesive material 23.

Still referring to FIG. 3, in the method M1, providing the replacement handle 10, as indicated by block 301, comprises forming the replacement handle 10 by a process comprising at least one of: casting, molding, vacuum-molding, injection-molding, and extruding; and providing the adhesive component 20, as indicted by block 302, comprises providing a material, such as a Bond Tech® adhesive, a 3M adhesive″, and a Facto® adhesive, by examples only.

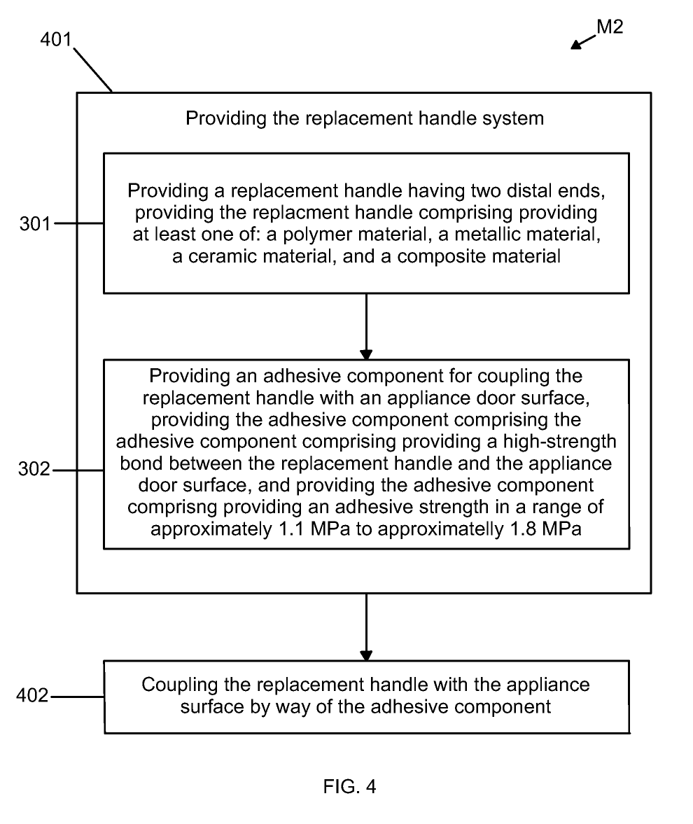

Referring to FIG. 4, this flow diagram illustrates a method M2 of replacing a handle, by way of a replacement handle system S, as shown in FIG. 1, in accordance with an embodiment of the present disclosure. The method M2 comprises: providing the replacement handle system S, as indicated by block 401, providing the system S, as indicated by block 401, comprising: providing a replacement handle 10 having two distal ends 11, providing the replacement handle 10 comprising providing at least one of: a polymer material, a metallic material, a ceramic material, and a composite material, as indicted by block 301; and providing an adhesive component 20 for coupling the replacement handle 10 with an appliance door surface D, providing the adhesive component 20 comprising providing at least one of a foam pad 21 and an adhesive material 23, providing the adhesive component 20 comprising providing a high-strength bond between the replacement handle 10 and the appliance door surface D, and providing the adhesive component 20 comprising providing an adhesive strength in a minimum range of approximately 1.1 MPa to approximately 1.8 MPa, as indicted by block 302, whereby decoupling of the replacement handle 10 from the appliance door surface D is minimized; and coupling the replacement handle 10 with the appliance surface by way of the adhesive component 20, as indicated by block 402.

Information as herein shown and described in detail is fully capable of attaining the above-described embodiments of the present disclosure and the presently preferred embodiment, if any, of the present disclosure, and is, thus, representative of the subject matter which is broadly contemplated by the present disclosure. The scope of the present disclosure fully encompasses other embodiments and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a device, an apparatus, a system, or a method to address each, and every, problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail is made, without departing from the spirit and scope of the present disclosure, as set forth in the appended claims, as is apparent, or may become apparent, to those of ordinary skill in the art, are also encompassed by the present disclosure.

### INDUSTRIAL APPLICABILITY

Generally, the present disclosure industrially applies to door handles. More particularly, the present disclosure industrially applies to after-market door handles. Even more particularly, the present disclosure industrially applies to easy-installation pre-market, market, as well as after-market door handles for refrigerators and freezers.

What is claimed:

1. A replacement handle system, the system comprising:
a replacement handle having two distal ends, the replacement handle comprising at least one of: a polymer material, a metallic material, a ceramic material, and a composite material; and
an adhesive component for coupling the replacement handle with an appliance door surface, the adhesive component comprising at least one of a foam pad and an adhesive material, the adhesive component providing a high-strength bond between the replacement handle and the appliance door surface, and the adhesive component comprising an adhesive strength in a minimum range of approximately 1.1 MPa to approximately 1.8 MPa,
whereby decoupling of the replacement handle from the appliance door surface is minimized.

2. The system of claim 1, wherein the replacement handle comprises a generally elongated curvilinear configuration.

3. The system of claim 1, wherein the replacement handle comprises a length in a range of approximately 12 in to approximately 20 in.

4. The system of claim 1, wherein each distal end of the two distal ends comprises a generally flat surface and a flange.

5. The system of claim 1, wherein each distal end of the two distal ends comprises a generally rectangular shape.

6. The system of claim 1, wherein the replacement handle comprises:
a generally hollow configuration; and
at least one of: at least one rib and at least one spar.

7. The system of claim 1, wherein the replacement handle is light-weight and comprises a weight range of approximately 80 grams to approximately 100 grams.

8. The system of claim 1, wherein the adhesive component comprises:
two pad portions having two generally planar pad surfaces;
an adhesive material disposed on each pad surface; and
two release plies disposed on the adhesive material,
wherein one generally planar pad surface of each pad portion is coupled with each distal end of the replacement handle by way of the adhesive material.

9. The system of claim 1, wherein the replacement handle is formed by a process comprising at least one of: casting, molding, vacuum-molding, injection-molding, and extruding.

10. The system of claim 1, wherein the adhesive component comprises at least one material of: a Bond Tech® adhesive, a 3M Adhesive®, and a Facto® adhesive, and any other suitable adhesive having an adhesive strength in a in a minimum range of approximately 1.1 MPa to approximately 1.8 MPa.

11. A method of fabricating a replacement handle system, the method comprising:
providing a replacement handle having two distal ends, providing the replacement handle comprising providing at least one of: a polymer material, a metallic material, a ceramic material, and a composite material; and
providing an adhesive component for coupling the replacement handle with an appliance door surface, providing the adhesive component comprising providing at least one of a foam pad and an adhesive material, providing the adhesive component comprising providing a high-strength bond between the replacement handle and the appliance door surface, and providing the adhesive component comprising providing an adhesive strength in a in a minimum range of approximately 1.1 MPa to approximately 1.8 MPa,
whereby decoupling of the replacement handle from the appliance door surface is minimized.

12. The method of claim 11, wherein providing the replacement handle comprises providing the replacement handle with a generally elongated curvilinear configuration.

13. The method of claim 11, wherein providing the replacement handle comprises providing the replacement handle with a length in a range of approximately 12 in to approximately 20 in.

14. The method of claim 11, wherein providing the replacement handle comprises providing each distal end of the two distal ends with a generally flat surface and a flange.

15. The method of claim 11, wherein providing the replacement handle comprises providing each distal end of the two distal ends with a generally rectangular shape.

16. The method of claim 11, wherein providing the replacement handle comprises:
providing a generally hollow configuration; and
providing at least one of: at least one rib and at least one spar.

17. The method of claim 11, wherein providing the replacement handle comprises providing the replacement handle with as light-weight and with a weight in a range of approximately 80 grams to approximately 100 grams.

18. The method of claim 11, wherein providing the adhesive component comprises:
providing two pad portions having two generally planar pad surfaces;
providing an adhesive material disposed on each pad surface; and
providing two release plies disposed on the adhesive material,
wherein providing the two pad portions comprises coupling one generally planar pad surface of each pad portion with each distal end of the replacement handle by way of the adhesive material.

19. The method of claim 11,
wherein providing the replacement handle comprises forming the replacement handle by a process comprising at least one of: casting, molding, vacuum-molding, injection-molding, and extruding, and
wherein providing the adhesive component comprises providing at least one material of: a Bond Tech® adhesive, a 3M Adhesive®, and a Facto® adhesive, and any other suitable adhesive having an adhesive strength in a minimum range of approximately 1.1 MPa to approximately 1.8 MPa.

20. A method of replacing a handle by way of a replacement handle system, the method comprising:
providing the replacement handle system, providing the system comprising:
providing a replacement handle having two distal ends, providing the replacement handle comprising providing at least one of: a polymer material, a metallic material, a ceramic material, and a composite material; and
providing an adhesive component for coupling the replacement handle with an appliance door surface, providing the adhesive component comprising providing at least one of a foam pad and an adhesive material, providing the adhesive component comprising providing a high-strength bond between the replacement handle and the appliance door surface, and providing the adhesive component comprising providing an adhesive strength in a minimum range of approximately 1.1 MPa to approximately 1.8 MPa,
whereby decoupling of the replacement handle from the appliance door surface is minimized; and
coupling the replacement handle with the appliance surface by way of the adhesive component.
